(19) United States
(12) Patent Application Publication
(10) Pub. No.: US 2010/0051076 A1
(43) Pub. Date: Mar. 4, 2010

(54) MULTIFUNCTIONAL WALKER APPARATUS

(75) Inventor: Brian McGann, York Harbor, ME (US)

Correspondence Address: CHRIS A. CASEIRO, VERRILL DANA, LLP, ONE PORTLAND SQUARE, PORTLAND, ME, 04112-0586, US

(73) Assignee: INTERCHANGEABLE MEDICAL WALKING STICKS LLC, York Harbor, ME (US)

(21) Appl. No.: 12/198,296

(22) Filed: Aug. 26, 2008

(51) Int. Cl. A61H 3/04; A61H 3/00

(52) U.S. Cl. 135/67; 135/65

(57) ABSTRACT

A multifunctional walker apparatus to assist individuals with varied walking capabilities. The apparatus includes a plurality of pole members, side members and a front connection member to form a conventional-appearing walker. At least one of the pole members is removable from the apparatus and is capable of being removably connected to a grip member to form a walking assistance device that is a cane or trekking stick. The cane or the trekking stick can be used separate from the walker form of the invention.

### BACKGROUND OF THE INVENTION

1. Field of the Invention

The present invention relates to an apparatus to facilitate walking. More particularly, the present invention relates to an apparatus that includes a plurality of removably connectable parts that alone or in combination may be used as a walker or other walking-assistive device, the form of which may be selected based upon the walking-assistive needs or interests of an individual.

2. Description of the Prior Art

Walking disorders are common. They are attributable to accidents, such as falls and collisions, for example, to maladies, such as vertigo, strokes and muscular degeneration, for example, and to surgery. Most walking disorders can be treated and, in many cases, complete recovery is possible. However, the rehabilitation process can be long and require that the individual undergoing rehabilitation use a plurality of walking-assistive devices at various points during the rehabilitation. For example, the multi-legged “walker” is a well known device for assisting the walking process. Walkers typically are used when the rehabilitating individual has a severe walking disorder and therefore is in need of significant assistance.

The cane also is a well known tool used by individuals to assist them while walking. Canes provide stability for the individual after the individual has recovered enough such as to no longer require a walker. Once stability has been achieved in the rehabilitating individual, the support cane design is unsuitable for the move from rehabilitation to a more rigorous recovery regimen. A device such as a trekking stick, however, is useful to the individual at the rigorous exercise stage of rehabilitation.

No existing device combines all of the benefits and features of a walker, a cane and a trekking stick in a single unit. Therefore, some individuals who undergo rehabilitation for a walking disorder are forced to acquire separately a walker, a cane, and one or more trekking poles to assist at various stages their rehabilitation.

What is needed therefore is an improved apparatus for facilitating walking that can be easily configurable into a variety of different arrangements by an individual as needed to meet any changes to the physical conditions of the individual over the course of increased physical ability and to allow the individual to avoid having to acquire and transport multiple separate walking-assistive devices.

### SUMMARY OF THE INVENTION

It is an object of the present invention to provide a multifunctional apparatus, which may be used, for example, by an individual undergoing rehabilitation or an individual who needs stability while walking. The apparatus includes three or more four pole members, each one of which may be of adjustable length and may be formed by one or more shafts. Some or all of the pole members may be combined in several ways to form a walker, one or two canes, and/or one or two trekking sticks. When the apparatus is to be used as a walker, all four poles are used, wherein one pair of the poles is connected together by a first side frame and a second pair of poles is connected together by a second side frame. In this arrangement, the four pole members are the legs of the walker. The walker form of the invention may be used by an individual who has great difficulty walking without substantial support.

Each pole member has an end that contacts an underlying surface, such as a floor or the ground. One or more of the pole members can be disconnected from the side frames and can be used to form part of a walking-assistive device. Each such removable pole member has a grip receiving end opposite from the substrate contacting end. The grip receiving end is capable of receiving a grip member. Optionally, the substrate contacting end may be fixed or it may be a removable substrate contacting member. Each one of the grip member and the optional substrate contacting member is of selectable form. A removable pole member therefore may be in the form of a cane or a trekking pole, for example. When such a disconnected pole member is arranged as a cane, it may be used by an individual who has a walking disorder that is less severe than would require the walker apparatus. When the disconnected pole member is arranged as a trekking pole, it may be used by an individual who wishes support to facilitate rigorous walking.

Therefore, a particular individual who suffers a walking disorder, such as one arising in an automobile accident, for example, could use the present invention as a walker until she recovered sufficiently enough to be able to use the invention as a cane, and then, after using it as a cane, could use the invention as a trekking pole as she partakes in advanced, rigorous walking exercise. In other words, the individual could use the present invention throughout her rehabilitation program: from the early stages when she is in need of greatest assistance, to the late stages when her walking ability has substantially recovered. These and other advantages of the present invention will become apparent upon review of the following detailed description, the accompanying drawings and the appended claims.

### BRIEF DESCRIPTION OF THE DRAWINGS

FIG. 1 is perspective view the walker form of the apparatus of the present invention, wherein the apparatus includes a plurality of pole members and a plurality of side frame members.

FIG. 2 is a perspective view of one of the pole members of the apparatus.

FIG. 3 is a perspective view of one of the side frame members of the apparatus.

FIG. 4A is an exploded side view of an embodiment of a walking-assistive device of the apparatus of the present invention with a first embodiment of the grip member.

FIG. 4B is a side view of the components of the device of FIG. 4A joined together.

FIG. 5 is a close-up cross-sectional view of the interface between a grip member and a pole member of the apparatus.

FIG. 6A is an exploded side view of a pole member of the invention.

FIG. 6B is a side view of the components of the pole member of FIG. 6A joined together.

FIG. 7 is a first side view of a second embodiment of the grip member of the present apparatus.

FIG. 8 is a second side view of the second embodiment of the grip member of the present apparatus removably connected to the pole member.

FIG. 9 is a side view of the first embodiment of the grip member of the present apparatus.

FIG. 10 is a side view of a first embodiment of an optional ground contact member of the present apparatus.

FIG. 11 is a side view of a second embodiment of an optional ground contact member of the present apparatus.

FIG. 12 is a side view of a third embodiment of an optional ground contact member of the present apparatus.

### DETAILED DESCRIPTION OF THE PREFERRED EMBODIMENT

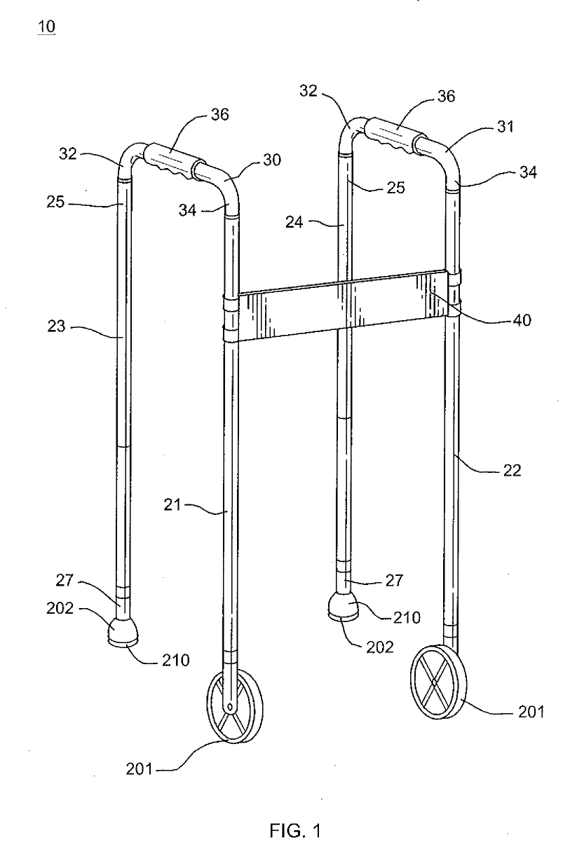

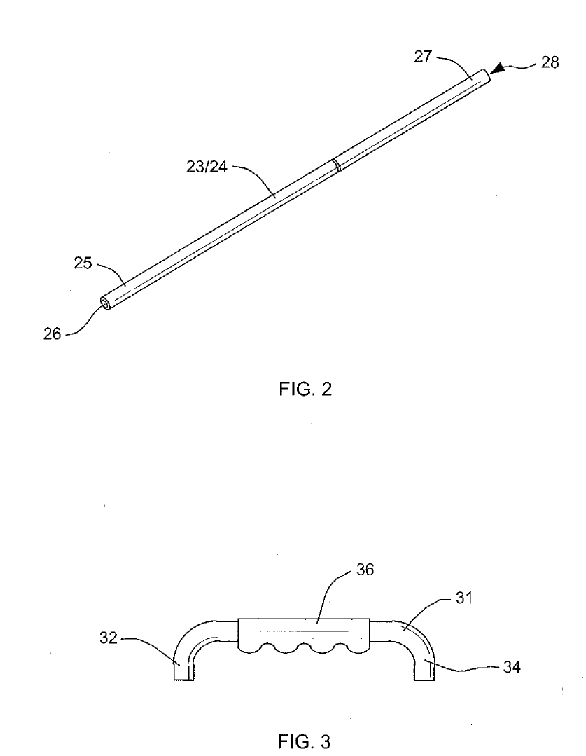

The present invention is a multifunctional walking-assistance apparatus 10 arranged to assist an individual with limited capability to walk under a variety of conditions. As shown in FIGS. 1-3, the apparatus 10 in walker form includes four pole members, comprising front pole members 21 and 22, and rear pole members 23 and 24. The apparatus 10 further includes first side frame member 30, second side frame member 31 and front connection member 40. Each rear pole member 23/24 has a first end 25 having an optional opening 26 and a second end 27 having an optional opening 28. Further, each side frame member 30/31 has a first end 32 and a second end 34. Each of first end 32 and second end 34 of the side frame member 30/31 is capable of being removably connected to the first end 25 of the corresponding one of the rear pole members 23/24. Each one of the front pole members 21/22 is either integrally formed with, or is removably connectable to, a corresponding one of the side frame members 30/31. Further, the front connection member 40 is either integrally formed with, or removably connectable to, the front pole members 21/22 and serves to help establish the overall support frame for walking and to maintain the structural integrity of the apparatus 10.

The apparatus 10 also includes a substrate contacting or ground contact member for each pole member. For example, the ground contact member may be a wheel 201, including the two wheels 201 shown in FIG. 1 that are connected to corresponding ones of the front pole members 21 and 22. The wheels 201 may be fixedly or removably connected to the front pole members 21 and 22. Alternatively, the front pole members 21 and 22 may have some other form of substrate contacting arrangement. One such alternative is a footing 202, such as that shown connected to the rear pole members 23 and 24 in FIG. 1. Each footing 202 has a ground contact region 210, which may be a surface gripping ground contact region. The ground contact member may be fixedly or removably connected to the rear pole members 23 and 24. Alternatively, the rear pole members 23 and 24 may have some other form of substrate contacting arrangement. Further and as noted, the footings 202 may alternatively be used to replace the wheels 201 on the first pole members 21 and 22. In the embodiment of the invention shown in FIG. 1, the apparatus 10 therefore may include two wheels 201 and two footings 202.

In the walker arrangement shown in FIG. 1, a user may use the apparatus 10 by gripping either or both of the side members 30 and 31 by handle 36 and moving the apparatus 10 along an underlying surface by the two wheels 201 while slightly raising the footings 202 from the underlying surface, or at least moving the ground contact members along the underlying surface. The apparatus 10 is arranged to provide sufficient support under the conditions typically expected for a traditional walker.

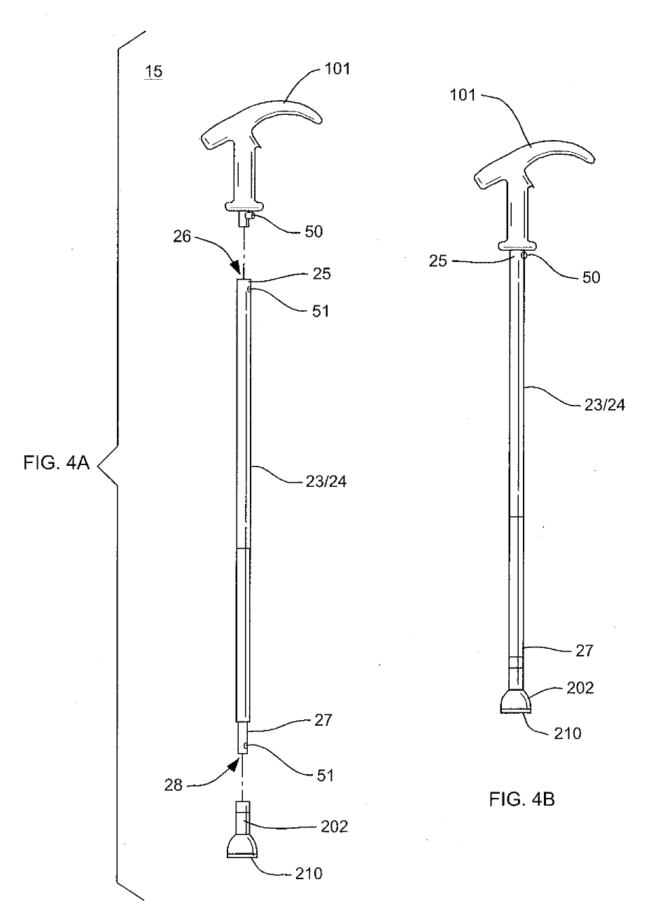

One or both of the rear pole members 23/24 may be removed from the apparatus 10 and arranged in the form of a walking-assistive device, such as walking-assistive device 15 of FIGS. 4A and 4B, for example. The walking-assistive device 15 is to be used separately from the apparatus 10 arranged as a walker. A portion of the apparatus 10 may be converted into the device 15. First, it is to be noted that opening 26 of first end 25 of the rear pole member 23/24 is capable of receiving a grip member, such as, but not limited to, first grip member 101. Optionally, the opening 28 of the second end 27 of the rear pole member 23/24 is capable of receiving the ground contact member, such as, but not limited to, the footing 202 having surface gripping ground contact region 210. Alternatively, footing 202 is permanently affixed to the rear pole member 23/24 at second end 27 in which case there is no need for opening 28.

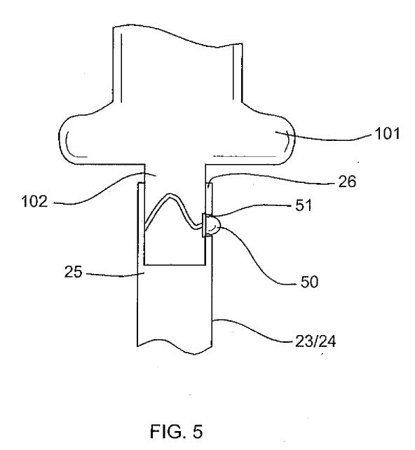

The skilled artisan will recognize that there are a large variety of options for connecting the first grip member 101 and the ground contact member to the rear pole member 23/24 in a removable or detachable way. For example, the first grip member 101 may include a depressible spring pin 50 shown in FIG. 5, and the first end 25 of the rear pole member 23/24 may include one or more selectable openings 51 for removably retaining the depressible pin 50 therein. Alternatively, the first end 25 of the rear pole member 23/24 may include a depressible spring pin and the first grip member 101 may include one or more selectable openings for removably retaining the depressible spring pin therein.

In the version represented in FIG. 5, the pole member 23/24 may be secured within the first grip member 101 by depressing the depressible spring pin 50 located on leg 102 of the first grip member 101, inserting the leg 102 of the first grip member 102 into opening 26 of the first end 25 of the rear pole member 23/24 and releasing the depressible spring pin 50. The leg 102 is pressed into the opening 26 until the depressible spring pin 50 reaches a selectable one of the openings 51 for fitting therein and releasably locking the first grip member 101 to the rear pole member 23/24. It is to be understood, however, that in some embodiments of the invention, the pole member 23/24 includes the pin 50 and the first grip member 101 includes the opening 51 for releasable engagement with the pin 50. It is also to be understood that, in some embodiments of the invention, the optionally removable ground contact member is connectable to end 27 of the pole member 23/24 by including either one of these two arrangements of the depressible spring pin 50 and opening 51 as part of the ground contact member and end 27 of the rear pole member 23/24.

As another example of the invention in which a subset of the primary components of the apparatus 10 may be removably connected together, the grip member, such as the first grip member 101 and/or the ground contact member, such as footing 202 may be removably connected to the rear pole member 23/24 by friction fit. That is, the leg 102 of the first grip member 101, for example, may be slidably fit into, and snuggly held in, opening 26 of the first end 25 of the rear pole member 23/24. As yet another example, the first grip member 101 may include male threading or a female threaded opening and the first end 25 of the rear pole member 23/24 may include corresponding compatible female/male threading for rotatable insertion and removable connection of the first grip member 101 and the rear pole member 23/24. It is to be understood, however, that the invention is not limited only to these examples of the removable connectability of any of the grip member designs described herein and/or any of the ground contact member designs described herein to either or both of the rear pole members 23 and 24.

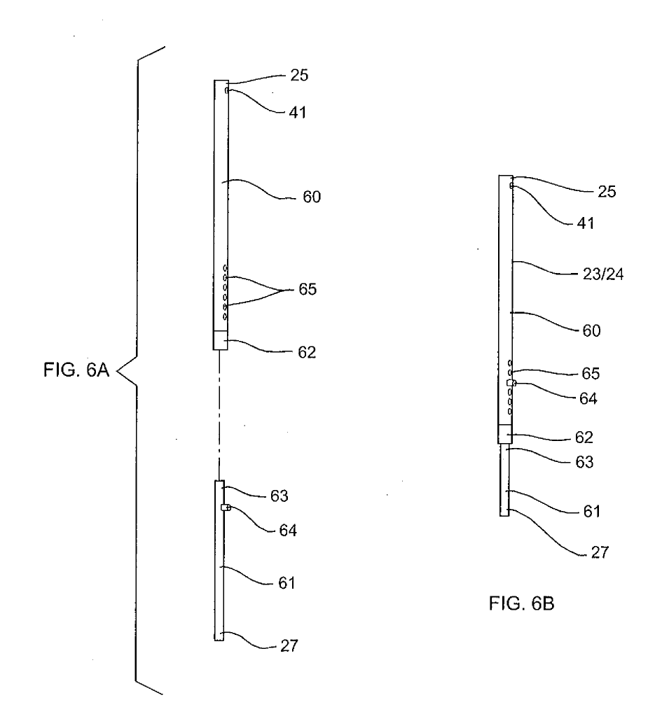

The length of the pole member 23/24 may be fixed, such as would be the case when the pole member 23/24 is a single component, or the length of the pole member 23/24 may be adjustable. When the length of the pole member 23/24 is to be adjustable, this may be achieved by adjusting the connection point between the pole member 23/24 and the grip member, and/or between the pole member 23/24 and the ground contact member. Alternatively, the length adjustment may be achieved by configuring the pole member 23/24 as a plurality of shafts that facilitate such adjustability. In one example, shown in FIGS. 6A and 6B, the pole member 23/24 is formed by an upper shaft 60 and a lower shaft 61. The lower shaft 61 may be adjustably, securably and removably retained within a portion of the upper shaft 60, such as is shown in FIG. 6B, or the upper shaft 60 may be adjustably, securably and removably retained within a portion of the lower shaft 61. (This latter arrangement of the upper shaft 60 within the lower shaft 61 is not shown).

The ability to adjust the upper shaft 60 with respect to the lower shaft 61, secure the upper shaft 60 to the lower shaft 61 and allow for the complete removal of the upper shaft 60 from the lower shaft 61 may be achieved, for example, by including a depressible pin 64 at or near either of lower end 62 of upper shaft 60 and upper end 63 of lower shaft 61, and a plurality of openings 65 at or near lower end 62 of upper shaft 60 or upper end 63 of lower shaft 61. When the pin 64 and the openings 65 are included as corresponding parts of the shafts 60 and 61, one may be slidably, removably and securably connected to a portion of the other by inserting the pin 64 into any one of the openings 65 to be selected based upon the desired length of the pole member. It is to be understood, however, that the invention is not limited to having this pin 64 and plurality of openings 65 arrangement to achieve the modifiable connectability of the shafts 60 and 61 for the purpose of pole member length adjustability. The skilled artisan will recognize that there are a variety of other ways this connection may be achieved.

The apparatus 10 preferably is sturdy and lightweight and may be formed from any one or more of a variety of materials. Materials from which the apparatus 10 may be formed therefore include, but are not limited to, for example, aluminum, titanium, stainless steel, carbon fiber, graphite, fiberglass, other nonmetallic materials and any combination thereof.

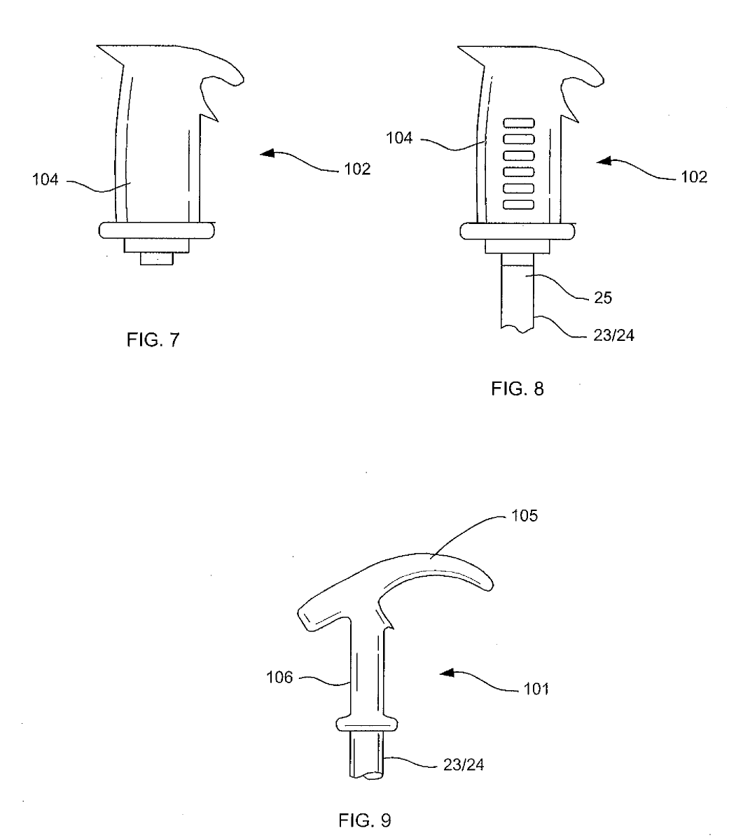

The first grip member 101 may be in any one of a plurality of forms and it may be in any one of a plurality of connection arrangements with respect to the rear pole member 23/24 when the first grip member 101 is removably connected to one of the rear pole members 23/24. A second embodiment of the grip member, second grip member 103 is substantially in the form shown in FIG. 7. When the second grip member 103 is used in forming device 15, grip region 104 may be substantially axially aligned with respect to the rear pole member 23/24, such as shown in FIG. 8, for example. The skilled artisan will recognize that any relatively upright arrangement of the grip region 104 with respect to the rear pole member 23/24 will allow a user of the device 15 to participate in a rigorous activity, such as fast-paced walking, for example, while gripping the rear pole member 23/24 of the device 15.

FIG. 9 illustrates the first embodiment of the grip member alone as the first grip member 101. When the first grip member 101 is removably connected to the rear pole member 23/24, grip region 105 may be substantially at a right angle with respect to the axis of the rear pole member 23/24, while grip body 106 is substantially axially aligned with the rear pole member 23/24. However, it is to be understood that when the first grip member 101 is removably connected to the rear pole member 23/24, the grip region 105 may be at an angle with respect to the rear pole member 23/24 that is somewhat different than a right angle, but at least sufficiently angled to permit the user to use the walking-assistive device 15 as a stabilizing structure, such as a cane, rather than as a rigorous exercise device. That is, the skilled artisan will recognize that any relatively right-angled arrangement of the grip region 105 with respect to the rear pole member 23/24 will allow a user of the walking-assistive device 15 to participate in a moderate activity, such as slow, steady and stable walking on a flat indoor surface, for example, while gripping the first grip member 101 when removably affixed to the rear pole member 23/24.

Either of the embodiments of the grip member of the present invention is designed for easy and comfortable gripping by a human hand. Therefore, the grip region 104/105 may include or may be formed as a soft covering, and/or is textured or otherwise formed, for improved gripping. Suitable soft materials include, but are not limited to, rubber, foam, and plastic, for example. As will be recognized by the skilled artisan, the grip member also may be in any one of a variety of shapes and be in any one of a variety sizes. The grip member may be shaped and/or sized to accommodate a variety of hand sizes, such as the small hands of a child or the large hands of an adult, for example. The grip member also may be shaped and/or sized to meet the needs of an individual having a particular hand disability, such as arthritis, for example, that prevents the individual from gripping the grip member completely or otherwise normally.

Further, because it is recognized that an individual who is missing one or both hands would benefit from the present invention, the grip member may be formed such as to allow secure gripping by a prosthetic device that does not include a human hand-like clasping member, such as a prosthetic device that includes a clip-like or tripod-like clasping member, for example. Therefore, the grip region 104/105 of the grip member may be formed from a rigid material, such as stainless steel, for example, to allow it to withstand being gripped by a durable clasping member, such as one that is also formed from stainless steel, for example.

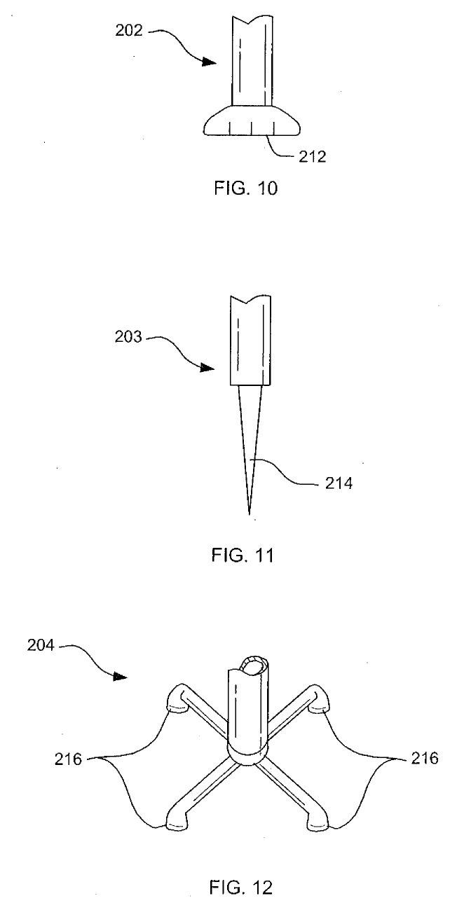

The ground contact member may have any one of a plurality of forms. In one example, the ground contact member is the footing 202 having surface gripping ground contact region 210 shown in FIGS. 1 and 10, for example. In another example, the ground contact member has a single, pointed ground contact region 214, such as ground contact member 203 shown in FIG. 11, for example.

Further, while the ground contact members 202/203 shown in FIGS. 10 and 11 each has only a single ground contact region 210, it is to be understood that the ground contact member may include a plurality of contact regions. For example, ground contact member 204 of FIG. 12 includes four contact elements 216.

The ground contact member is not limited to the forms of the ground contact members shown in the FIGURES. The skilled artisan will recognize that the ground contact member may have any one of a variety of forms. The skilled artisan will further recognize that any one or more of the ground contact members shown may be used with either the apparatus 10 or the device 15.

When the apparatus 10 or the device 15 is being used, the ground contact member is able to contact any underlying surface on which the user may be present, including, but not limited to, interior flooring of all varieties, asphalt, concrete, dirt, sand, ice, snow, and the surface of an exercise device, such as the moving platform of a treadmill device, for example. The ground contact member may be selected to reduce the possibility that an individual will fall, slip or stumble while using any of the arrangements of the invention on a particular underlying surface. For example, the ground contact member 203 of FIG. 11 may be selected when the user of the apparatus 10 or the device 15 is to walk on an icy surface. The ground contact member also may include other features that have not already been shown or described with respect to the ground contact member to facilitate ground contact. For example, the ground contact member may include a high frictional surface at the contact region for improved contact between the apparatus 10 or the device 15 and the underlying surface.

Further, the ground contact member and/or the grip member may be selected based on the rehabilitative needs and/or physical ability of the user of the apparatus 10 or the device 15. For example, the footing 202 of FIG. 10 may be selected to be used in conjunction with the first grip member 101 when the user has reduced walking ability, and therefore needs to use the device 15 to walk on flat surfaces. As another example, the ground contact member 203 of FIG. 11 may be selected to be used in conjunction with the second grip member 103 where the user is to partake in a more strenuous activity than walking on a flat surface, such as hiking an inclined rocky terrain, for example.

It is to be further understood that any portion of the apparatus 10 may be fitted with a removable or integral receptacle or equivalent device for receiving and holding another part of the apparatus 10/device 15. For example, either or both of the rear pole members 23/24 may include a friction fit receptacle that snaps thereon for connecting a grip member, for example, to the rear pole member 23/24. The skilled artisan will recognize that other arrangements for convenient placement of, and access to, optional grip members and/or ground contact members, are possible.

Because the apparatus 10 of the present invention includes a plurality of removably connectable parts, whenever a part, such as the ground contact member, for example, becomes worn or otherwise defective, the user of the apparatus 10 may replace only that defective part without having to replace the entire apparatus 10. Therefore, the apparatus 10 is cost effective. The ability to remove parts also is convenient to the user because this capability allows the user the option of carrying around certain spare parts, and therefore not an entire replacement for the apparatus 10, when these parts become defective.

Further, the apparatus 10 of the present invention is easy to transport. Because the apparatus 10 includes a plurality of removably connectable parts and the length of each pole member optionally may be slidably adjustable, the apparatus 10 may be easily and quickly disassembled and/or the length of one or more pole members may be slidably reduced, such as when the apparatus 10 is to be stored in the overhead compartment of a commercial airplane, for example, for later reassembly and use. To further enhance the transportability of the apparatus 10, the apparatus 10 may include an optional storage container, such as a rigid plastic case or a soft canvas bag, for example, for carrying all or some of the parts of the apparatus 10.

In summary, the apparatus 10 of the present invention is a multi-functional walking assistance device. It includes a first embodiment in the form of a walker comprising one or more removable parts. The apparatus is fully functional when all parts are joined together. When one or more of the removable parts are removed, the apparatus 10 ceases being available as a functioning walker and, instead, may be converted into a walking assistance device such as device 15. The device 15 may be formed by taking a pole member of the apparatus 10 and applying a grip member thereto. The grip member selected may transform the pole member into either a cane or a trekking stick. An individual may thus acquire a single apparatus and use that apparatus to move from substantial walking assistance embodied in the walker form of the invention, to some assistance embodied in the cane form of the invention, and finally to minimal balance assistance when walking rigorously embodied in the trekking stick form of the invention. Through the present invention there is no longer a need to separately purchase a walker, a cane and a trekking stick.

While the present invention has been described with particular reference to certain embodiments of the apparatus, it is to be understood that it includes all reasonable equivalents thereof as defined by the following appended claims.

1. An apparatus for walking assistance, the apparatus comprising:
a. one or more front pole members;
b. a first rear pole member;
c. a second rear pole member;
d. means for removably connecting the front pole members to the first rear pole member and the second rear pole member, wherein the means for removably connecting includes a handle; and
e. one or more grip members,
wherein when the pole members and the means for removably connecting are joined together a walker is formed, and wherein either or both of the first rear pole member and the second rear pole member includes means for removably connecting the grip members directly thereto.

2. The apparatus of claim 1 wherein the lengths of the first rear pole member and the second rear pole member are adjustable.

3. The apparatus of claim 1 wherein each of the first rear pole member and the second rear pole member is formed by an upper shaft and a lower shaft, wherein the upper shaft is removably connectable to the lower shaft.

4. The apparatus of claim 1 wherein the grip member has a grip region, wherein when the grip member is removably connected to one of the first rear pole member and the second rear pole member it is substantially axially aligned with that rear pole member.

5. The apparatus of claim 1 wherein the grip member has a grip region, wherein when the grip member is removably connected to one of the first rear pole member and the second rear pole member, the grip region is substantially at a right angle with respect to the axis of that rear pole member.

6. The apparatus of claim 1 further comprising a plurality of ground contact members corresponding in number to the total number of the one or more front pole member, the first rear pole member and the second rear pole member, wherein each ground contact member is connected to a corresponding one of the pole members.

7. The apparatus of claim 6 wherein the ground contact members of the one or more front pole members are wheels.

8. The apparatus of claim 6 wherein the ground contact members of the first rear pole member and the second rear pole member are footings.

9. The apparatus of claim 4 wherein the grip region includes or is formed as a soft covering.

10. The apparatus of claim 5 wherein the grip region includes or is formed as a soft covering.

11. The apparatus of claim 1 wherein the means for removably connecting the grip members is a spring pin or is compatible male/female threading.

12. An apparatus for walking assistance, the apparatus comprising:
a. one or more front pole members;
b. a first rear pole member;
c. a second rear pole member;
d. means for removably connecting the front pole members to the first rear pole member and the second rear pole member, wherein the means for removably connecting includes a handle;
e. a first grip member including a grip region substantially axially aligned with a primary axis of either of the first rear pole member and the second rear pole member when removably connected thereto;
f. a second grip member including a grip region substantially at a right angle with respect to a primary axis of either of the first rear pole member and the second rear pole member when removably connected thereto,
wherein when the pole members and the means for removably connecting are joined together a walker is formed, and wherein either or both of the first rear pole member and the second rear pole member includes means for removably connecting the first grip member or the second grip member directly thereto.

13. The apparatus of claim 12 wherein the means for removably connecting the grip member is a spring pin or is compatible male/female threading.
